(19) United States
(12) Patent Application Publication
(10) Pub. No.: US 2026/0309278 A1
(43) Pub. Date: Oct. 8, 2026

(54) METHOD FOR FILLING A FLUID STORAGE, FLUID DISCHARGE DEVICE FOR A FLUID OR FLUID MIXTURE, AND ASSOCIATED SYSTEM

(71) Applicant: Langenstein & Schemann GmbH, Coburg (DE)

(72) Inventors: Friedrich Herdan, Coburg-Bertelsdorf (DE); Lothar Bauersachs, Weidhausen (DE); Harald Barnickel, Coburg (DE)

(21) Appl. No.: 19/639,986

(22) Filed: Apr. 6, 2026

(30) Foreign Application Priority Data
Apr. 4, 2025 (DE) 10 2025 113 259.3

(51) Int. Cl. F17C 5/00; G05D 9/12

(52) U.S. Cl. CPC F17C 5/007; G05D 9/12; F17C 2205/0323; F17C 2205/0352; F17C 2221/03; F17C 2227/0142; F17C 2250/034; F17C 2250/0417; F17C 2250/043; F17C 2250/0439; F17C 2250/0443; F17C 2250/0452

(57) ABSTRACT

The invention relates to a method for filling at least one fluid storage, a fluid discharge device for a fluid or fluid mixture, in particular for a biogas mixture stored in a fluid storage, and a system comprising a fluid discharge device and a first fluid storage.

### CROSS-REFERENCE TO RELATED APPLICATIONS

This application claims the benefit of and priority to German Patent Application No. 10 2025 113 259.3, filed Apr. 4, 2025, entitled “Verfahren zum Befüllen eines Fluidspeichers, Fluidabführvorrichtung für ein Fluid oder Fluidgemisch und zugehöriges System,” the entire content of which is incorporated herein by reference.

### BACKGROUND

### 1. Technical Field

The underlying invention relates to a method for filling a fluid storage, a fluid discharge device for a fluid or fluid mixture, in particular for a biogas mixture stored in a fluid storage, and an associated system comprising a fluid discharge device, a first fluid storage, and a second fluid storage.

### 2. Background and Relevant Art

Biogas is understood above and below to mean a gas produced by the fermentation of biomass, for example in a biogas plant such as part of a landfill site, a sewage treatment plant or an agricultural business. Biogas can be used, for example, to supply local heating systems, power stations or combustion engines in vehicles. However, biogas has an average calorific value of only 60% compared to normal pipeline-quality natural gas. To produce high-quality, pipeline-grade biomethane, biogas is collected in pipelines and pumped to a biomethane processing plant (also known as an RNG plant), where it is processed in several steps in large purification plants. The most cost-intensive step is the separation of CH₄ and CO₂.

However, many agricultural biogas producers are located in remote areas where there are no pipelines to a biomethane processing plant. For this reason, biogas producers are dependent on processes that allow biogas to be transported to a biomethane processing plant.

One way of transporting biogas is to fill mobile tanks, for example in the form of a tank in a tanker vehicle or a tank trailer for a motor vehicle, with biogas and then transport them to a biomethane processing plant. Such a mobile tank can, for example, be a compression storage or a fluid adsorption storage.

In fluid adsorption storages, fluids, in particular biogas, are adsorbed, for example, onto carbon-based adsorption materials, known as adsorbents (singular: adsorbent). Such adsorption materials or adsorbents include, for example, activated carbon, periodically mesoporous organosilicon dioxide, controllably porous glasses, mesoporous silicon dioxide, carbon-mesoporous material (or: carbon-mesoporous media, carbon-mesoporous Korea, carbon-mesostructures from Korea), monolithic carbon, in particular monolithic nanoporous carbon, or monomodal microporous carbon-based adsorbents.

Adsorption is understood above and below to mean the attachment of gases, molecules or dissolved substances to the interface of a solid or liquid phase, the adsorption material or the adsorbent. A molecule of a fluid that is not adsorbed by the adsorption material but remains in the fluid bulk phase is referred to as an adsorptive. The molecules of the fluid that are bound to the adsorbents, i.e., the adsorption material, are referred to as adsorbates. The adsorbent and the adsorbate are collectively referred to as the adsorbent-adsorbate complex.

The removal of fluids stored in fluid adsorption storages is performed at least partially by desorption. This is the reverse reaction of adsorption. During desorption, the gas adsorbed to the adsorption material, the adsorbed molecules or the adsorbed dissolved substances are detached from the adsorption material by applying energy.

Adsorption materials are often very porous, which means they have a high specific surface area. This is often accompanied by limited thermal conductivity. The adsorption of a molecule is typically an exothermic process in which adsorption enthalpy is released. In other words, the adsorption material is usually heated by adsorption. However, heating the adsorption material can promote desorption in the adsorption material. In other words, heating the adsorption material can reduce the adsorption capacity of the adsorption material. The same applies to desorption. The desorption of a molecule is typically an endothermic process in which desorption enthalpy is extracted from the adsorption material. In other words, the adsorption material is usually cooled by desorption. However, cooling the adsorption material can counteract desorption in the adsorption material. In other words, cooling the adsorption material can increase the adsorption capacity of the adsorption material.

Adsorption and desorption processes are important for the process of storing fluids in adsorption storage systems and for the process of extracting fluids from adsorption storage systems. For rapid emptying of the adsorption storage system, a low adsorption capacity or adsorptivity of the adsorbents for the corresponding adsorbates can be advantageous at the moment of extracting fluids from adsorption storage systems, whereas for rapid filling of the adsorption storage at the moment of storing fluids in adsorption storages, a high adsorption capacity or adsorptivity of the adsorbents for the corresponding adsorbates may be advantageous. In addition to the adsorptivity, in particular the selective adsorptivity for the respective adsorbates, the adsorption and desorption processes are generally also dependent on the system temperature and the partial pressure or concentration of the adsorptive or adsorptives.

As already explained above, previous adsorption and desorption processes can influence the temperature that prevails in the adsorption material of a fluid adsorption storage during subsequent adsorption and desorption processes. In addition, the partial pressures in fluid adsorption storages change during the filling or emptying of the fluid adsorption storages. The maximum volume of fluid that can be extracted from a fluid adsorption storage in a given period of time, or the maximum volume of fluid that can be filled into a fluid adsorption storage in a given period of time, depends not only on the temperature and pressure conditions at the start of these respective processes, but also on the change in temperature and pressure conditions over the course of the extraction or filling process, i.e., on the temperature gradient over time and the pressure gradient over time.

In known methods for storing and/or extracting fluids in or from fluid adsorption storages, the complex interactions between adsorption and desorption processes, temperature and pressure changes and the mass flow of the fluid are usually not taken into account or are not taken into account sufficiently, with the result that the adsorption capacity of the adsorbents is higher than desired during withdrawal processes from fluid adsorption storage on the one hand, and lower than desired during filling processes of fluid adsorption storage on the other. With regard to extraction processes from fluid adsorption storage systems, this can have the disadvantage that a fluid adsorption storage system can only be emptied slowly or incompletely. Incomplete emptying of a fluid adsorption storage can in turn be associated with the disadvantage that the fluid adsorption storage can store a smaller additional amount of fluid in a subsequent filling process. In other words, the storage capacity of fluid adsorption storages is not optimally utilized if the complex interactions between adsorption and desorption processes, temperature and pressure changes, and the mass flow of the fluid are not sufficiently taken into account.

### BRIEF SUMMARY

The invention is therefore based on the task of specifying a new method, a new device and a new system which at least largely avoids the disadvantages of the prior art.

This problem is solved by the independent claims. Embodiments result from the dependent claims and the following description.

According to one embodiment, a method and a system are proposed in which transport containers are made available to biogas plants or their operators, into which the biogas is filled or loaded on-site at the biogas plant, and once sufficiently filled, the filled transport containers are then collected along with the biogas they contain, emptied at a utilization plant, and the biogas is utilized. Utilization of the biogas occurs in particular by separating the main components of the biogas from one another, at least to a large extent, and directing them to individual utilization processes. For example, the methane can be separated from the biogas and used for energy production, such as in a combined heat and power system or for pure electricity generation, or it can be used as a feedstock for chemical synthesis. Since there is generally only a limited intermediate storage volume available for biogas in biogas plants (typically the gas volumes present in the fermentation plant or composting plant, which are limited, for example, by a flexible roof), it must be ensured that the biogas, which is generally produced continuously in the biogas plant, is also continuously removed via the transport containers. This means that a transport container that is full or sufficiently filled with biogas is then collected in a timely manner, and a new, empty transport container is provided in its place. For this purpose, the fill level or degree of filling of the transport containers is monitored, preferably also via a data connection to a control station or remote maintenance station that is, in particular, also linked to the utilization plant, and regular reports or data regarding the fill level are transmitted in order to dispatch a replacement transport container or an empty transport container in a timely manner so that it can replace a full container. Preferably, several transport containers are assigned to or delivered to a biogas plant and dated to provide a certain degree of redundancy for the removal and filling of the biogas. For example, two, three, four, five, or even more transport containers may be made available, depending on the size of the biogas plant and the volume of biogas produced per unit of time. Transport containers are preferably delivered by means of transport vehicles such as agricultural vehicles, trucks, or, where applicable, rail-bound vehicles. The filling system (fluid discharge device) at the biogas plant can now be transported along with the transport container and, where applicable, integrated with it or delivered with it, or it may also be arranged in a stationary manner on the delivery vehicle. A fluid discharge device draws the biogas from the storage at the biogas plant and pumps this biogas into the respective transport container. To this end, the fluid discharge device typically comprises a pumping device or suction pump and one or more connections and valves for connecting to and disconnecting from an outlet of the biogas storage of the biogas plant. The fluid discharge device further comprises a measuring device for measuring the fill level of the biogas in the transport container, or a measuring device that measures the volume flow already flowing into or pumped into the transport container, or the total volume of the biogas, and thereby directly or indirectly determines the amount of gas already transported or pumped into the transport container. The transport containers are preferably adsorption containers containing an adsorption material for adsorbing the gas components contained in the biogas, in particular methane and carbon dioxide. The adsorption material may be at least one of the following materials: activated carbon, periodically mesoporous organosilicon dioxide, controllably porous glasses, mesoporous silicon dioxide, mesoporous carbon materials (or: carbon-mesoporous media, carbon-mesoporous Korea, carbon-mesostructures from Korea), monolithic carbon, in particular monolithic nanoporous carbon, or monomodal microporous carbon-based adsorbents.

If the transport container is such an adsorption container, the biogas in the transport container is typically brought to an overpressure of approximately 60 to 80 bar by means of the fluid discharge device and its pumping device. However, it is also possible for the transport containers to be conventional compression vessels or pressure vessels into which the biogas is introduced at an excessively high pressure, typically >200 bar, thereby causing it to liquefy at least partially. In this variant, corresponding compressors are then provided as pumping devices, which are either carried along with the transport vehicle or arranged stationary at the biogas plant. When a transport container is full or the maximum filling level or capacity for the biogas is reached, a signal is sent from a local reporting device to the control center indicating that a new transport container must be dispatched via a transport vehicle. Alternatively, the current fill level or fill rate is continuously transmitted to the control center via the corresponding measurement signal or measurement data, and the control center itself compares the current measurement value or signal with a maximum value corresponding to full capacity. If this is the case, the control center then determines that a full container must be replaced, and an empty transport container dispatched. To determine the fill level or degree of filling, the volume flow or mass flow can be measured and summed or integrated, or a pressure at the container's inlet or inside the container can be determined, which then serves as the measure of the transport container's fill level.

In the biogas plant, organic waste or animal excrement such as slurry or manure, or plant-based substances, in particularly biological waste (or: food waste), can be fermented or decomposed and converted into carbon dioxide, methane, and other decomposition products, usually in smaller percentages. A filter or purification unit may also be provided on-site at the biogas plant, in particular with activated carbon filters or activated carbon columns, through which the biogas is passed for purification, so that undesirable components are filtered out and the biogas acquires a purer composition of methane and carbon dioxide. Such gas purification may be provided off-site or on-site on the transport vehicle, particularly in combination with a fluid discharge device also provided on the transport vehicle, so that the biogas is first purified using the purification device on the transport vehicle and then the purified biogas is pumped into the transport containers on the transport vehicle using the fluid discharge device. The on-site fluid discharge device can also be used on-site to empty a transport container that has already been filled, if the methane is to be used on-site, for example for energy generation or heating.

The method according to the invention is a method for filling at least one fluid storage, comprising:
(a) providing a first fluid storage, in particular a biogas storage, which
(a1) comprises at least one outlet valve, and
(a2) comprises at least one fluid or fluid mixture containing molecules of at least two different chemical substances, in particular a biogas mixture containing methane molecules and carbon dioxide molecules, and
(b) providing a second fluid storage having at least one inlet valve;
(c) providing a fluid discharge device comprising at least one supply line, at least one discharge line, a control unit, and a measuring unit for detecting measured values of one or more of the following measured variables:
pressure within the supply line of the fluid discharge device,
temperature within the supply line of the fluid discharge device,
mass flow through the fluid discharge device; and
fluid concentration within the supply line of the fluid discharge device;
(d) connecting the supply line of the fluid discharge device to the closed outlet valve of the first fluid storage;
(e) connecting the discharge line of the fluid discharge device to the inlet valve of the second fluid storage; and
(f) opening the outlet valve of the first fluid storage and allowing the fluid to flow from the first fluid storage through the open outlet valve and through the fluid discharge device into the second fluid storage;
(g) detecting measured values of the one or more measured variables by the measuring unit;
(h) receiving a control signal corresponding to the one or more detected measured values by the control unit; and
(i) determining a fill level value corresponding to the fill level of the second fluid storage by the control unit based on the control signal.

The biogas stored in an exemplary fluid storage has, for example, a methane concentration of 60 vol. % and a carbon dioxide concentration of 40 vol. %. The pressure in the filled fluid storage is, for example, 6 MPa.

Connecting the supply line of the fluid discharge device to the outlet valve and opening the outlet valve can be performed and monitored by an operator. Alternatively, these process steps can also be performed in an automated manner by a suitable system.

The first fluid storage may, for example, be the biogas storage of a biogas production plant.

The fluid discharge device may, for example, be located at the biogas production plant, at the first fluid storage, or on a tanker vehicle.

According to a further embodiment of the method of the invention, the fill level value of the first fluid storage and/or the second fluid storage is displayed on a display of the fluid discharge device or is transmitted via a communication unit of the second fluid storage connected to the control unit, either wired or wirelessly, to a receiving unit, in particular a receiving unit of a computer or server.

According to a further embodiment of the method of the invention, the fluid discharge device further comprises a suction pump and/or a mass flow controller.

A suction pump is understood above and below to be a pump which can suck in a medium to be conveyed, for example a fluid, by generating a negative pressure. A suction pump can also be referred to as a vacuum pump. The suction pump can be implemented, for example, as a reciprocating piston pump, rotary vane pump, slide valve pump, rolling piston pump or screw vacuum pump.

Preferably, the suction pump is operated to generate the suction pressure at least when the pressure in the first fluid storage has dropped from substantially 6 MPa to substantially 2.5 MPa after the outlet valve is opened.

According to a further embodiment of the method of the invention, the control unit is configured or adapted as a control unit that controls one or more of the following control variables:
the level of suction pressure generated by the suction pump;
frequency or speed of the suction pump; and
size of the effective flow opening of the mass flow controller.

According to a further embodiment of the method of the invention, the fluid discharge device further comprises:
a first discharge line;
a second discharge line; and
a changeover valve adapted or configured to receive a switching signal from the control unit to perform switching from a first position to a second position;
wherein the method further comprises:
providing a third fluid storage having at least one inlet valve;
connecting the first discharge line of the fluid discharge device to the inlet valve of the second fluid storage, wherein the changeover valve in the first position fluidically connects the outlet valve of the first fluid storage to the inlet valve of the second fluid storage, and wherein the changeover valve is in the first position prior to the opening of the outlet valve of the first fluid storage;
connecting the second discharge line of the fluid discharge device to the inlet valve of the third fluid storage, wherein the changeover valve, in the second position, fluidically connects the outlet valve of the first fluid storage to the inlet valve of the third fluid storage;
determining that a fill level value corresponding to the fill level of the second fluid storage is above a first threshold value by the control unit based on the control signal;
generating a switching signal by the control unit for switching from the first position to the second position;
receiving the switching signal by the changeover valve;
switching the changeover valve to the second position so that the fluid flowing out of the first fluid storage through the open outlet valve flows through the fluid discharge device into the third fluid storage when the fill level value corresponding to the level of the second fluid storage is above the first threshold value.

According to a further embodiment of the method of the invention, the fill level value transmitted via a wired or wireless connection to the receiving unit of the computer or server triggers the provision of an additional fluid storage when the fill level value exceeds a second threshold value.

According to a further embodiment of the method of the invention, the first fluid storage is under a storage pressure in a high-pressure range, in particular between 2 and 10 MPa, and in a first separation mode, the following process steps are performed on or with the first fluid storage:
opening the outlet valve of the first fluid storage and allowing the fluid to flow out of the first fluid storage through the open outlet valve in a first operating mode, in particular in a passive mode without suction pressure from the suction pump, until the storage pressure reaches a low-pressure range, in particular below 2 MPa, and/or as long as the outflowing fluid contains predominantly methane molecules,
following the first operating mode, in particular following the passive mode, operating the fluid discharge device in a second operating mode, in particular in an active mode, with the following features:
generating a suction pressure at the open outlet valve of the first fluid storage by means of the suction pump, and
discharging the fluid from the first fluid storage through the fluid discharge device by means of the suction pressure.

The device according to the invention is a fluid discharge device, in particular for use in a method according to one of the preceding claims, for a fluid or fluid mixture, in particular for a biogas mixture stored in a fluid storage,
wherein the device comprises a supply line, at least one discharge line, a control unit, and a measuring unit for detecting measured values of one or more of the following measured variables:
pressure within the supply line of the fluid discharge device,
temperature within the supply line of the fluid discharge device,
mass flow through the fluid discharge device; and
fluid concentration within the supply line of the fluid discharge device.

According to a further embodiment of the fluid discharge device of the invention, the fluid discharge device further comprises a display for displaying a fill level value of at least one fluid storage connected to the fluid discharge device and/or a communication unit connected to the control unit, which is configured or adapted such that the fill level value can be transmitted via a wired or wireless connection to a receiving unit, in particular a receiving unit of a computer or server.

According to a further embodiment of the device of the invention, the fluid discharge device further comprises a suction pump, and wherein the device is configured or adapted to generate a suction pressure by means of the suction pump and/or wherein the device further comprises a mass flow controller, and wherein the device is configured or adapted to regulate the mass flow through the fluid discharge device to a mass flow setpoint by means of the mass flow controller, wherein the mass flow setpoint is, in particular, time-dependent.

According to a further embodiment of the device of the invention, the magnitude of the suction pressure is time-dependent, and the suction pressure is generated by the suction pump along a predetermined or preset temporal profile.

According to a further embodiment of the device of the invention, the fluid discharge device further comprises:
a first discharge line;
a second discharge line; and
a changeover valve that is configured or adapted to receive a switching signal from the control unit to perform switching from a first position to a second position, wherein the supply line of the fluid discharge device is fluidically connected to the first discharge line in the first position and the supply line of the fluid discharge device is fluidically connected to the second discharge line in the second position.

The system of the invention is a system, particularly for use in one of the preceding methods, comprising a fluid discharge device according to one of the fluid discharge devices described above, a first fluid storage, and a second fluid storage.

According to a further embodiment of the system of the invention, the second fluid storage is a fluid adsorption storage.

The second adsorption storage may, for example, comprise adsorbents with a gravimetric methane storage capacity of at least 0.13 kg of methane per 1 kg of adsorbents. Furthermore, the second fluid adsorption storage may, for example, have a volumetric storage capacity of at least 0.08 kg of methane per 1 litre of fluid adsorption storage volume at a temperature of 20° C. and a pressure of 6 MPa.

According to a further embodiment of the system of the invention, the system comprises a third fluid storage, wherein the third fluid storage is, in particular, a fluid adsorption storage.

Previously and subsequently, a first operating mode can be understood to mean, on the one hand, a passive mode without suction pressure from the suction pump and, on the other hand, a mode in which the suction pump generates a first suction pressure or a suction pressure along a first pressure curve. Furthermore, a second operating mode can be understood to mean, on the one hand, an active mode with suction pressure from the suction pump and, on the other hand, a mode in which the suction pump generates a second suction pressure that is higher than the first suction pressure or a suction pressure along a second pressure curve. For example, the suction pump is operated in the first operating mode with a suction pressure of 100 kPa and in the second operating mode with a suction pressure of 1 MPa. Alternatively, in the first operating mode, the suction pump is initially operated at a suction pressure of 100 kPa, with the suction pressure rising linearly or non-linearly to a suction pressure of 500 kPa over the duration of the first operating mode, and wherein the suction pump is initially operated in the second operating mode with a suction pressure of 1 MPa and the suction pressure increases linearly or non-linearly to a suction pressure of 3 MPa over the duration of the second operating mode.

In preferred embodiments of the invention, a method (logistics method) and a system (logistics system) are proposed in which transport containers are provided to the biogas plants or their operators, into which the biogas is filled or loaded on-site at the biogas plant or at a collection station connected to the biogas plant via pipelines, and once sufficiently filled, the filled transport containers containing the biogas are then collected and emptied at a utilization plant, where the biogas or at least components thereof, such as methane, are subsequently utilized.

In a biogas plant (or: biogas reactor), organic waste or animal excrement such as slurry or manure, or plant-based substances, particularly bio waste (or: food waste), are typically fermented or decomposed and converted into carbon dioxide, methane, and other decomposition products, usually in smaller percentages.

The utilization of biogas in the utilization plant occurs primarily by separating the main components of the biogas from one another, at least to a large extent, and directing them to individual utilization processes. For example, the methane can be separated from the biogas and used for energy production, for instance in a combined heat and power system or simply for electricity generation, or it can be used as a feedstock for chemical synthesis.

Since there is generally only a limited temporary storage capacity for biogas in biogas plants (typically the gas volumes present in the fermentation or composting plant, which are limited, for example, by a flexible roof), it must now be ensured that the biogas, which is generally produced continuously in the biogas plant, is also continuously removed via the transport containers.

In one embodiment, this is ensured by collecting a transport container that is full or sufficiently filled with biogas in a timely manner and providing a new, empty transport container in its place. For this purpose, the fill level or degree of filling of the transport containers is monitored, preferably also via a data connection to a control station or remote maintenance station that is, in particular, also linked to the utilization plant, and regular reports or data regarding the fill level are transmitted so that a replacement transport container or an empty transport container can be dispatched in a timely manner to replace a full container.

Preferably, several transport containers are assigned to or delivered to a biogas plant and dated to provide a certain degree of redundancy for the removal and filling of the biogas. For example, two, three, four, five, or even more transport containers can be made available, depending on the size of the biogas plant and the volumes of biogas produced per unit of time.

The transport containers are preferably transported to and from the site using transport vehicles, such as agricultural vehicles, trucks, or, where applicable, rail vehicles.

A fluid discharge device for discharging biogas from the biogas plant or collection station can now be transported along with the transport vehicle and its container, and may be integrated into or supplied with the vehicle, or it may be permanently mounted on the vehicle or at the biogas plant or collection station. The fluid discharge device discharges the biogas from the storage at the biogas plant and pumps this biogas into the respective transport container. To this end, the fluid discharge device typically comprises a pumping device or suction pump and one or more connections and valves for connecting to and disconnecting from an outlet of the biogas storage of the biogas plant. The fluid discharge device further comprises a measuring device for measuring the fill level of the biogas in the transport container, or a measuring device that measures the volume flow already flowing into or pumped into the transport container, or the total volume of the biogas, and thereby directly or indirectly determines the amount of gas that has already been transported or pumped into the transport container. The transport containers are preferably adsorption containers containing an adsorption material for adsorbing the gas components contained in the biogas, in particular methane and carbon dioxide. The adsorption material may be at least one of the following materials: activated carbon, periodically mesoporous organosilicon dioxide, controllably porous glasses, mesoporous silicon dioxide, carbon-mesoporous Korea, monolithic carbon, in particular monolithic nanoporous carbon, and monomodal microporous carbon-based adsorbents.

If the transport container is such an adsorption container, the biogas in the transport container is typically brought to a suitable overpressure by means of the fluid discharge device and its pumping device. However, it is also possible for the transport containers to be conventional compression vessels or pressure vessels into which the biogas is introduced at an even higher pressure, thereby at least partially liquefying it. In this variant, corresponding compressors are then provided as pumping devices, which are either carried along with the transport vehicle or arranged stationarily at the biogas plant.

When a transport container is full or the maximum filling level or capacity for the biogas is reached, a signal is sent from a local reporting device to the control center indicating that a new transport container must be dispatched via a transport vehicle. Alternatively, the current fill level or fill rate is continuously transmitted to the control center via the corresponding measurement signal or data, and the control center itself compares the current measurement value or signal with a maximum value corresponding to full capacity. If this is the case, it determines that a full container must be replaced and an empty transport container dispatched. To determine the fill level or degree of filling, the volumetric flow or mass flow can be measured and summed or integrated, or a pressure at the inlet of the container or inside the container can be determined, which then serves as a measure of the transport container's fill level.

A filter or purification unit may also be provided on-site at the biogas plant, in particular with activated carbon filters or activated carbon columns, through which the biogas is passed for purification, so that undesirable components are filtered out and the biogas acquires a purer composition of methane and carbon dioxide. Such gas purification may be provided not only in a stationary or on-site configuration but also on the transport vehicle, particularly in combination with a fluid discharge device also provided on the transport vehicle, such that the biogas is first purified by the purification device and then the purified biogas is pumped into the transport containers using the fluid discharge device.

In some embodiments, the on-site fluid discharge device can also be used on-site to empty a transport container that has already been filled, if the methane is to be used on-site, for example for energy generation or heating.

Furthermore, in an additional or alternative embodiment for on-site utilization of the biogas, a special device for converting the methane contained in the biogas into methanol may be provided.

For this purpose, for example, a special internal combustion engine can either be installed or placed on-site at the biogas plant or carried along with the transport vehicle. Such an engine, such as it is offered by the company Emvolon (see https://emvolon.com or https://www.auto-motor-und-sport.de/tech-zukunft/alternative-antriebe/methan-umwandlung-verbrennungsmotoren/), converts a significant portion of the methane into methanol through a special adjustment of the combustion parameters.

The methanol can then be stored in tanks or dedicated transport containers and, similar to the transport containers for biogas, particularly adsorption containers, can be transported away while full and then replaced with new empty transport containers via a central logistics system. Here, too, the fill level or level of the methanol tank or transport container for methanol can be continuously measured and transmitted to the monitoring or control center, which then arranges for the dispatch of a new empty transport container well in advance of final filling. If multiple transport containers are provided, multiple transport containers can of course also be delivered and picked up.

The logistics, transport system, and transport procedures for the biogas containing methane, as well as for the methanol already produced from the biogas or the methane it contains, can be provided in combination or individually.

The advantage of the proposed logistics is the significantly lower on-site effort and the mobility, since no gas pipelines need to be laid to the biogas plant, and thus even decentralized or remotely located biogas plants can be supplied accordingly, or their production can be purchased. It is also possible for the biogas from a biogas plant or a biogas reactor to be transported over part of the route via gas pipelines to a collection station, where the transport containers are then filled, particularly if storage of the transport containers on the premises of the biogas plant is undesirable or even impossible.

### BRIEF DESCRIPTION OF THE DRAWINGS

The invention is further explained below with reference to exemplary embodiments. Reference is also made to the drawings, in which the following are shown schematically:

FIG. 1 illustrates a system comprising a first fluid storage of a biogas production plant, a fluid discharge device, a second fluid storage, and a computer,

FIG. 2A illustrates a system comprising a first fluid storage, a fluid discharge device in a passive mode, a second fluid storage, and a third fluid storage,

FIG. 2B illustrates a system comprising a first fluid storage, a fluid discharge device in an active mode, a second fluid storage, and a third fluid storage,

FIG. 3 illustrates a fluid discharge device for discharging a fluid in a system according to one of FIG. 1 through 2B, and

FIG. 4 illustrates a system comprising a first fluid storage of a biogas production plant, a fluid discharge device, a second fluid storage, and a tanker vehicle with a third fluid storage.

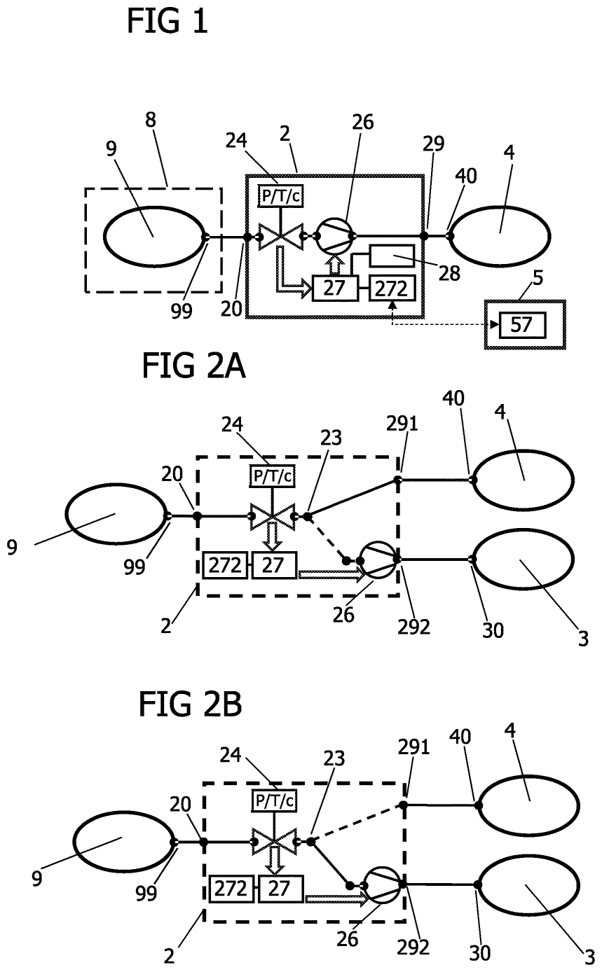

Corresponding parts and dimensions are designated by the same reference signs in FIG. 1 through 4.

### DETAILED DESCRIPTION

According to FIG. 1, a fluid stored in a first fluid storage 9 of a biogas production plant, in particular biogas, is discharged through a fluid discharge device 2 into a second fluid storage 4. An outlet valve 99 of the first fluid storage 9 is connected to a supply line 20 of the fluid discharge device 2. The fluid discharge device 2 comprises a measuring unit 24, a suction pump 26, a control unit 27, a communication unit 272, and a display 28. The second fluid storage 4 comprises an inlet valve 40. The inlet valve 40 is connected to a discharge line 29 of the fluid discharge device. The communication unit 272 is in communication with a communication unit 57 of a computer 5. The computer 5 is located remotely from the biogas production plant 8, for example in the form of an external server or as part of an external control system that monitors the fill levels of fluid storages. The measuring unit 24 is configured or adapted to determine the pressure, temperature, and fluid concentration within the supply line 20, as well as the mass flow through the fluid discharge device 2. Corresponding measured values of the pressure, temperature, and fluid concentration in the supply line 20, as well as the mass flow through the fluid discharge device 2, are transmitted from the measuring unit 24 to the control unit 27. The control unit is configured or adapted to determine a fill level of both the first fluid storage 9 and the second fluid storage 4 based on the received measured values. The fill level values corresponding to the determined fill levels of both the first fluid storage 9 and the second fluid storage 4 are displayed to an operator on the display 28, in particular on a screen or a touchscreen. In addition, the fill level values are transmitted from the control unit 27 to a communication unit 272, and the fill level values are transmitted from the communication unit 272 via a wired or wireless connection to a computer 5 located away from the biogas production plant 8. The computer 5 receives the transmitted measured values via the communication unit 57. In this way, the computer 5, located at a distance from the biogas production plant 8, can store and monitor the fill level values of the fluid storages 9 and 4. For example, in response to a fill level threshold being exceeded, particularly automatically, an additional fluid storage may be provided for connection to the fluid discharge device 2.

As shown in FIG. 2A, a fluid discharge device 2 includes a changeover valve 23 that, in a first position, connects the supply line 20 of the fluid discharge device 2 to a first discharge line 291 connected to a second fluid storage 4. In a second position of the changeover valve 23, the supply line 20 is connected via a suction pump 26 and a second discharge line 292 to a third fluid storage 3. The position of the changeover valve 23 shown in FIG. 2A corresponds to the first position, in which the supply line 20 is connected to the first discharge line 291. In the first position of the changeover valve 23, the fluid discharge device 2 operates in a passive mode. Shortly after an outlet valve 99 is opened, primarily methane gas flows out of a fluid storage 9 filled with biogas under high pressure. As a result, after the outlet valve 99 is opened, the methane concentration in the fluid storage 9 initially decreases more rapidly than the carbon dioxide concentration. In other words, during an initial phase of discharging biogas from the fluid storage 9, the relative proportion of carbon dioxide in the fluid storage 9 increases. Preferably, the biogas discharged in the passive mode of the fluid discharge device 2, which consists primarily of methane, is discharged into the second fluid storage 4. The second fluid storage 4, which is to be filled primarily with methane during the first phase of discharge, can also be referred to as a methane storage. After a certain period of time following the opening of the outlet valve 19, first, the pressure in fluid storage 9 has decreased, and second, the relative proportion of carbon dioxide in the biogas remaining in fluid storage 9 has increased. Consequently, in a second phase of biogas discharge, carbon dioxide typically flows primarily through the outlet valve 99 into the supply line 20 of the fluid discharge device 2. To prevent the methane storage 4 from filling with biogas that does not primarily consist of methane during the second phase of biogas discharge, the changeover valve 23 is switched to the second position after the first phase of discharge, i.e., connected to the third fluid storage 3 via the suction pump 26 and the second discharge line 292.

As shown in FIG. 2B, a fluid discharge device 2 includes a changeover valve 23 that, in a first position, connects the supply line 20 of the fluid discharge device 2 to a first discharge line 291 connected to a second fluid storage 4. In a second position of the changeover valve 23, the supply line 20 is connected via a suction pump 26 and a second discharge line 292 to a third fluid storage 3. The position of the changeover valve 23 shown in FIG. 2B corresponds to the second position, in which the supply line 20 is connected to the second discharge line 292. In the second position of the changeover valve 23, the fluid discharge device 2 is operated in the active mode. After the end of a passive mode of the fluid discharge device 2, for example as shown in FIG. 2A, in a second phase of discharge as shown in FIG. 2B, carbon dioxide typically flows primarily through the outlet valve 19 into the supply line 20 of the fluid discharge device 2. Preferably, the biogas discharged in the active mode of the fluid discharge device 2, which primarily comprises carbon dioxide, is discharged into the third fluid storage 3. The third fluid storage 3, which is to be filled primarily with carbon dioxide in the second phase of discharge, may also be referred to as a carbon dioxide storage. The suction pump 26 generates a suction pressure that discharges the remaining fluid of the fluid storage 9 from the fluid storage 9. The generated suction pressure increases the total amount of material that can be discharged from the fluid storage 9, or the total volume of biogas that can be discharged.

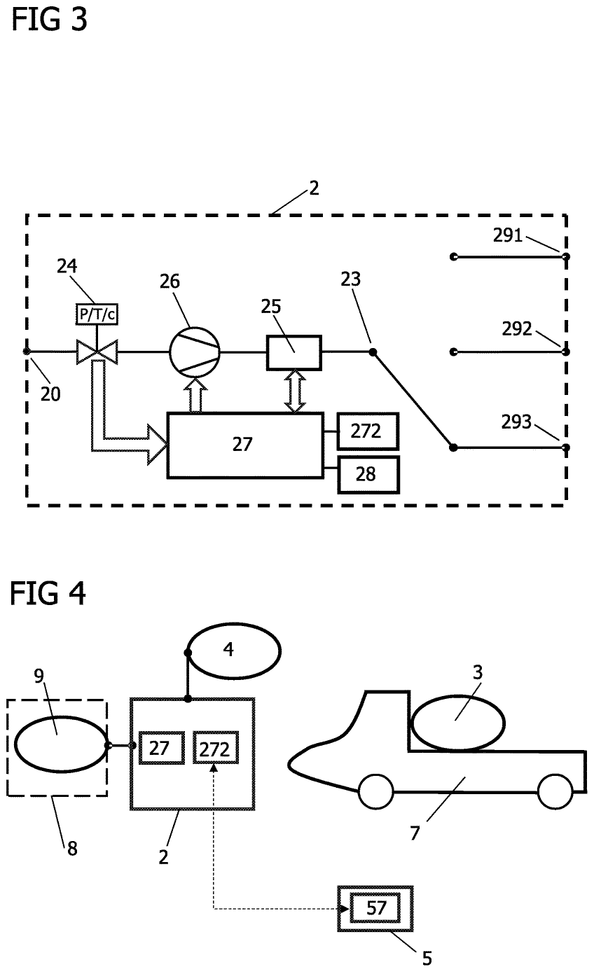

As shown in FIG. 3, a fluid discharge device 2 has a supply line 20, a measuring unit 24, a mass flow controller 25, a suction pump 26, a control unit 27 and a changeover valve 23. The changeover valve 23 connects the outlet of the suction pump 26 to one of three discharge lines, namely the first discharge line 291, the second discharge line 292, or the third discharge line 293. Furthermore, the fluid discharge device comprises a communication unit 272 connected to the control unit 27, as well as a display 28 connected to the control unit 27. The display 28 is, in particular, implemented as a touchscreen. The control unit 27 can determine a fill level of the fluid storages connected to the fluid discharge device 2 based on the measured values received from the measuring unit 24. For example, a first fluid storage (not shown) is connected to the supply line 20, and a second fluid storage (not shown) is connected to the third discharge line 293. By measuring the pressure, temperature, and fluid concentration in the supply line 20, as well as the mass flow through the fluid discharge device, the control unit 27 can determine a fill level of the first fluid storage and a fill level of the second fluid storage. The fill level values corresponding to the determined fill levels can be displayed on the display 28. In addition, the determined fill level values can be transmitted to the communication unit 272. The communication unit 272 can transmit the determined fill level values to an external computer or an external server, in particular via a wired or wireless connection. The suction pump can, for example, be frequency-controlled or speed-controlled. The measuring unit 24 detects the pressure, temperature and gas concentration in the supply line 20 and generates corresponding measured values. The control unit 27 receives the measured values from the measuring unit 24. The mass flow controller 25 detects the mass flow or flow rate through the fluid discharge device 2 and generates corresponding measured values. The control unit 27 receives the measured values from the mass flow controller 25. Alternatively, the measuring unit 24 detects the pressure, temperature, gas concentration in the supply line 20 and also the mass flow or flow rate through the fluid discharge device 2 and generates corresponding measured values, whereby the control unit 27 also receives the measured values corresponding to the mass flow or flow rate from the measuring unit 24. The control unit 27 controls the operation of the mass flow controller 25 and the suction pump 26. For example, the control unit 27 activates the suction pump 26 when the measuring unit 24 detects a pressure below 2.5 MPa and the control unit 27 receives a control signal corresponding to this detected pressure. Preferably, the suction pump 26 has a variable compression ratio, i.e., a variable ratio between the outlet pressure and the inlet pressure of the suction pump 26. Furthermore, the suction pump 26 generates the level of suction pressure depending on the level of the detected pressure corresponding to the received control signal. For example, the suction pump 26 generates a suction pressure of 50 kPa when the measuring unit 24 detects a pressure below 2.5 MPa and above 250 kPa within the supply line 20 of the fluid discharge device 2, whereas the suction pump 26 generates a suction pressure of 500 Pa when the measuring unit 24 detects a pressure below 250 kPa within the supply line 20 of the fluid discharge device 2. The control unit 27 can be a regulating unit which, for example, controls the frequency or speed of the suction pump 26, in particular as a function of the measured values obtained by the measuring unit 24 or the mass flow controller 25. In other words, the measuring unit 24 and the mass flow controller 25 record the actual values, for example, of the pressure, temperature and gas concentration in the supply line 20 and the actual value of the mass flow or flow rate through the fluid discharge device 2 and forward these to the control unit 27 as a regulating unit. In the control unit 27 as the regulating unit, the actual values of the pressure, temperature, gas concentration and mass flow or flow rate are compared with corresponding target value values that are stored or at least retrievable in the control unit 27 as the regulating unit. If there is a deviation between the actual values and the target value values, a control algorithm in the control unit 27 as the regulating unit determines an adjustment of the operating parameters, for example of the suction pump 26 and the mass flow controller 25, and transmits correspondingly adjusted operating instructions to the suction pump 26 and the mass flow controller 25. The suction pump 26 is then operated, for example, at a changed frequency or at a changed speed. After the adjusted operating instructions have been transmitted, the mass flow controller 25 is operated, for example, in a changed position of a control valve, so that the size of the effective flow opening of the mass flow controller 25 after receiving the adjusted operating instructions is changed compared to the size of the effective flow opening before receiving the adjusted operating instructions.

The suction pump 26 can, for example, be operated in a passive mode as a first operating mode in such a way that it is inactive in this passive mode, i.e., it does not generate any suction pressure. In an active mode following the passive mode as a second operating mode, the suction pump 26 can, for example, be operated in such a way that it is active in the active mode and generates a suction pressure of approximately 3 MPa. Alternatively, the level of suction pressure generated in the active mode can follow a defined time curve. Alternatively, the level of suction pressure generated in active mode can follow a time curve that can be defined by an operator. The level of suction pressure generated in active mode can, for example, follow a time curve that essentially corresponds to a logarithmic or exponential relationship between the level of suction pressure and time. The level of suction pressure generated in active mode can, for example, also follow a time curve comprising a plurality of sections, each section being selectable in particular from a time curve that essentially corresponds to a linear, quadratic, logarithmic or exponential relationship between the level of suction pressure and time.

Alternatively, the suction pump 26 can be operated in the first operating mode in such a way that it is initially inactive, is then activated while still in the first operating mode, and then generates a low suction pressure in the first operating mode, for example at a level of 100 kPa. Alternatively, the suction pump 26 can be operated in the first operating mode in such a way that it is already active at the start of the first operating mode and generates a low suction pressure, for example 100 kPa. The level of suction pressure generated in the first operating mode can alternatively follow a defined time curve. Alternatively, the level of suction pressure generated in the first operating mode can follow a time curve that can be defined by an operator. The level of suction pressure generated in the first operating mode can, for example, follow a time curve that essentially corresponds to a logarithmic or exponential relationship between the level of suction pressure and time. The level of the suction pressure generated in the first operating mode can, for example, also follow a time curve comprising a plurality of sections, each section being selectable in particular from a time curve that essentially corresponds to a linear, quadratic, logarithmic or exponential relationship between the level of the suction pressure and time. Preferably, the maximum suction pressure generated by the suction pump 26 in the first operating mode is lower than the maximum suction pressure in the second operating mode. The changeover valve 23 may also be omitted and the fluid may be passed through the suction pump 26 in the first and second operating modes, which is controlled or regulated accordingly. For example, in passive mode, the suction pump may be passive or remain deactivated and allow the fluid to flow through, and only be activated in active mode.

Alternatively, the mass flow controller 25 can be arranged after the measuring unit 24 and before the suction pump 26.

The supply line 20 may comprise a first supply line, a second supply line and a third supply line, which can be fluidically connected to the measuring unit 24 by means of a supply line changeover valve. Switching between the first supply line, the second supply line and the third supply line is performed by means of the supply line changeover valve in the same way as switching between the discharge lines 291 to 293 by means of the changeover valve 23. By switching between the first supply line, the second supply line and the third supply line, several filled fluid reservoirs can be connected to the fluid discharge device 2 at the same time. For example, a fluid from a fluid reservoir connected to the first supply line can first be discharged through the fluid discharge device 2, then, after switching the supply line switch valve, a fluid from a fluid reservoir connected to the second supply line can be discharged through the fluid discharge device 2, and finally, after switching the supply line switch valve again, a fluid from a fluid reservoir connected to the third supply line can be discharged through the fluid discharge device 2.

As shown in FIG. 4, a third fluid storage 3 is mounted on a tanker vehicle 7. A first fluid storage 9 of a biogas production plant 8 is connected to a fluid discharge device 2. The fluid discharge device 2 comprises a control unit 27 and a communication unit 272. Furthermore, the fluid discharge device 2 is connected to the second fluid storage 4. The fluid discharge device 2 is configured or adapted to determine fill level values of the first fluid storage 8 and the second fluid storage 4. The communication unit 272 transmits the determined fluid level values to a communication unit 57 of a computer 5. The computer 5 is located at a distance from the biogas production plant 8, for example as part of a control system for monitoring fluid storage levels. The computer 5 monitors the fill levels of the first fluid storage 8 and the second fluid storage 4. If the fill level of the fluid storage 4 exceeds a threshold value, the computer 5 triggers an alarm and automatically initiates the provision of a third fluid storage 3. As shown in FIG. 4, the third fluid storage 3 is transported by the tanker vehicle 7 to the biogas production plant 8 and is made available there for connection to a discharge line of the fluid discharge device 2.

### List of Reference Signs

2 fluid discharge device
20 supply line
23 changeover valve
24 measuring unit
25 mass flow controller
26 suction pump
27 control unit
272 communication unit
28 display
29 discharge line
291 first discharge line
292 second discharge line
293 third discharge line
3 fluid storage
30 inlet valve
4 fluid storage
40 inlet valve
5 computer system
57 communication unit
7 tanker vehicle
8 biomethane production plant
9 fluid storage

1. A method for filling at least one fluid storage, comprising:
(a) providing a first fluid storage, in particular a biogas storage, which
(a1) comprises at least one outlet valve and
(a2) comprises at least one fluid or fluid mixture containing molecules of at least two different chemical substances, in particular a biogas mixture containing methane molecules and carbon dioxide molecules, and
(b) providing a second fluid storage having at least one inlet valve;
(c) providing a fluid discharge device comprising at least one supply line, at least one discharge line, a control unit, and a measuring unit for detecting measured values of one or more of the following measured variables:
pressure within the supply line of the fluid discharge device,
temperature within the supply line of the fluid discharge device,
mass flow through the fluid discharge device; and
fluid concentration within the supply line of the fluid discharge device;
(d) connecting the supply line of the fluid discharge device to the closed outlet valve of the first fluid storage;
(e) connecting the discharge line of the fluid discharge device to the inlet valve of the second fluid storage; and
(f) opening the outlet valve of the first fluid storage and allowing the fluid to flow from the first fluid storage through the open outlet valve and through the fluid discharge device into the second fluid storage;
(g) detecting measured values of the one or more measured variables by the measuring unit;
(h) receiving a control signal corresponding to the one or more detected measured values by the control unit; and
(i) determining a fill level value corresponding to the fill level of the second fluid storage by the control unit based on the control signal.

2. The method according to claim 1, wherein the fill level value of the first fluid storage and/or the second fluid storage is:
displayed on a display of the fluid discharge device, or
transmitted via a communication unit of the second fluid storage connected to the control unit, either wired or wirelessly, to a receiving unit, in particular a receiving unit of a computer or server.

3. The method according to claim 1, wherein the fluid discharge device further comprises a suction pump and/or a mass flow controller.

4. The method according to claim 3, wherein the control unit is configured or adapted as a control unit that controls one or more of the following control variables:
the level of suction pressure generated by the suction pump;
frequency or speed of the suction pump; and
size of the effective flow opening of the mass flow controller.

5. The method according to claim 1, wherein the fluid discharge device further comprises:
a first discharge line;
a second discharge line; and
a changeover valve adapted or configured to receive a switching signal from the control unit to perform switching from a first position to a second position;
wherein the method further comprises:
providing a third fluid storage having at least one inlet valve;
connecting the first discharge line of the fluid discharge device to the inlet valve of the second fluid storage, wherein the changeover valve in the first position fluidically connects the outlet valve of the first fluid storage to the inlet valve of the second fluid storage and wherein the changeover valve is in the first position prior to the opening of the outlet valve of the first fluid storage;
connecting the second discharge line of the fluid discharge device to the inlet valve of the third fluid storage, wherein the changeover valve in the second position fluidically connects the outlet valve of the first fluid storage to the inlet valve of the third fluid storage;
determining that a fill level value corresponding to the fill level of the second fluid storage is above a first threshold value by the control unit based on the control signal;
generating a switching signal by the control unit for switching from the first position to the second position;
receiving the switching signal by the changeover valve;
switching the changeover valve to the second position so that the fluid flowing out of the first fluid storage through the open outlet valve flows through the fluid discharge device into the third fluid storage when the fill level value corresponding to the level of the second fluid storage is above the first threshold value.

6. The method according to claim 2, wherein:
the fill level value transmitted via a wired or wireless connection to the receiving unit of the computer or server triggers the provision of an additional fluid storage when the fill level value exceeds a second threshold value.

7. The method according to claim 3, wherein the first fluid storage is under a storage pressure in a high-pressure range, in particular between 2 and 10 MPa, and in a first separation mode, the following process steps are performed on or with the first fluid storage:
opening the outlet valve of the first fluid storage and allowing the fluid to flow out of the first fluid storage through the open outlet valve in a first operating mode, in particular in a passive mode without suction pressure from the suction pump, until the storage pressure reaches a low-pressure range, in particular below 2 MPa, and/or as long as the outflowing fluid contains predominantly methane molecules,
following the first operating mode, in particular following the passive mode, operating the fluid discharge device in a second operating mode, in particular in an active mode, with the following features:
generating a suction pressure at the open outlet valve of the first fluid storage by means of the suction pump, and
discharging the fluid from the first fluid storage through the fluid discharge device by means of the suction pressure.

8. A fluid discharge device, in particular for use in a method according to claim 1, for a fluid or fluid mixture, in particular for a biogas mixture stored in a fluid storage,
wherein the device comprises a supply line, at least one discharge line, a control unit, and a measuring unit for detecting measured values of one or more of the following measured variables:
pressure within the supply line of the fluid discharge device,
temperature within the supply line of the fluid discharge device,
mass flow through the fluid discharge device; and
fluid concentration within the supply line of the fluid discharge device.

9. The fluid discharge device according to claim 8, wherein the fluid discharge device further comprises a display for displaying a fill level value of at least one fluid reservoir connected to the fluid discharge device and/or a communication unit connected to the control unit, which is configured or adapted such that the fill level value can be transmitted via a wired or wireless connection to a receiving unit, in particular a receiving unit of a computer or server.

10. The fluid discharge device according to claim 8, wherein one or more of:
(i) the fluid discharge device comprises a suction pump, and
the fluid discharge device is configured or adapted to generate a suction pressure by means of the suction pump, and/or
(ii) the fluid discharge device comprises a mass flow controller, and
the fluid discharge device is configured or adapted to control the mass flow through the fluid discharge device to a mass flow setpoint by means of the mass flow controller, wherein the mass flow setpoint is, in particular, time-dependent.

11. The fluid discharge device according to claim 10, wherein:
the magnitude of the suction pressure is time-dependent, and
the suction pressure is generated by the suction pump along a predetermined or preset temporal profile.

12. The fluid discharge device according to claim 8, wherein the fluid discharge device further comprises:
a first discharge line;
a second discharge line; and
a changeover valve that is configured or adapted to receive a switching signal from the control unit for switching from a first position to a second position;
wherein the supply line of the fluid discharge device:
is fluidically connected to the first discharge line in the first position, and
is fluidically connected to the second discharge line in the second position.

13. A system, comprising a fluid discharge device according to claim 8, a first fluid storage, and a second fluid storage.

14. The system according to claim 13, wherein the second fluid storage is a fluid adsorption storage.

15. The system according to claim 13, further comprising:
a third fluid storage,
wherein the third fluid storage is, in particular, a fluid adsorption storage.
